(19) United States
(12) Patent Application Publication
(10) Pub. No.: US 2008/0110284 A1
(43) Pub. Date: May 15, 2008

(54) Sectional Circulating Assembly for a Ball Screw

(76) Inventors: Hung-Sung Pan, Taichung Industrial Park (TW); Wen-Chia Wu, Taichung Industrial Park (TW)

Correspondence Address: Banger Shia, 204 Canyon Creek, Victoria, TX, 77901, US

(21) Appl. No.: 11/559,365

(22) Filed: Nov. 13, 2006

(51) Int. Cl. F16H 3/06

(52) U.S. Cl. 74/89.23

(57) ABSTRACT

A sectional circulating assembly for a ball screw comprises an inner circulating block and an outer circulating block. In assembly, the inner circulating block is initially placed between the screw shaft and the nut before the balls and the screw shaft are positioned, thus preventing the balls from dropping out and the interference with the threads. After the balls and the screw shaft are positioned, the outer circulating block is placed into the nut and to be engaged with the inner circulating block, and the outer circulating block is fixed to the nut. This method can maintain the tightness of the nut, thus preventing the leakage of noise.

### BACKGROUND OF THE INVENTION

1. Field of the Invention

The present invention relates to a ball screw, and more particularly to a sectional circulating assembly for a ball screw that is easily assembled and can reduce the generation of noise.

2. Description of the Prior Art

Nowadays, ball screw is used more and more widely in modern industries. As a linear transmission means, the ball screw not only has high precision but also has the advantages of low frictional loss, high energy conversion ratio, low noise and high rigidity. Hence, it is self-evident that the ball screw is very important to various industrial mechanisms. In order for the balls between the screw shaft and the nut to circulate smoothly and for relieving the stress therebetween, the nut is usually provided at both ends thereof with two circulation cassettes for cooperating with the threads of the screw shaft and the balls. And the circulation cassette is a key structure for enabling the balls circulation from the screw shaft and the nut. Therefore, how to develop an improved and competitive circulation cassette is the common goal that the manufactures are striving for.

The conventional circulating assemblies are essentially classified by way of assembly into two categories: axial assembly (as shown in FIG. 1), and radial assembly (not shown). Please refer to the following detailed description:

Axial Assembly:

FIG. 1 shows a ball screw of axial assembly type disclosed in U.S. Pat. No. 4,357,838, which comprises: a nut 10, a screw shaft 11, a plurality of balls 12 and a circulating element 13. The circulating element 13 is installed into the end surface of the nut 10 for guiding the balls 12 into the circulation hole (not shown) of the nut 10. A very important portion of the circulating element 13 is called nail portion 14 that straddles the threads of the nut 10 for smoothly jointing the helical grooves. This axial assembly has the following disadvantages:

First, although this circulating element 13 has the advantages of smooth rolling path and high rotation speed, since the nail portion 14 is engaged in the helical groove 101 of the screw shaft 11, any end of the helical groove 101 must be open so as to facilitate the installation of the nail portion 14 of the circulating element 13. In other words, the helical groove must extends to the shoulder portion of the screw shaft 11, and the helical groove leaves a notch in the in the abutting surface of the shoulder portion, as a result, the integrality of the diameter of the abutting surface is damaged (the outer periphery of the abutting surface is not round). When both ends of the screw shaft 11 are mounted on bearing seats of a machine (not shown), and the motor of the machine starts to rotate the screw shaft 11, the rotation inertia will effect an axial load on both ends of the screw shaft 11. And due to the integrality of the diameter of the abutting surface is damaged, the axial load cannot be evenly distributed on the both ends of the screw shaft 11. This will generate great pressure against the end surface (not shown) of the bearing seats, causing damage to the bearing seats, as a result of that, the screw shaft 11 will be deformed during rotation, adversely affecting the circulation of the rolling elements, but will reduce the service life of the screw shaft. Therefore, it is uneconomical.

Second, the screw shaft 11 is initially inserted at a proper position in the nut 10, and the balls 12 are placed therebetween, and finally the circulating element 13 should be installed at an appropriate angle, otherwise it can be assembled. Therefore, the assembly of the circulating element 13 is complicated and requires a skilled worker.

Third, when both ends of the screw shaft 11 are mounted on bearing seats of a machine, the screw shaft 11 is then inserted through the nut 10 and filling balls, the ball screw is assembled by hand. The ball screw probably needs to be subjected to adjustment process (the respective components of the ball screw should be adjusted) during assembly, because of the adjustment process, the balls may drop out of the ball screw when the nut 10 is disengaged from the screw shaft 11 or when the nut 10 moves out of travel.

Radial Assembly:

To overcome the abovementioned problems, another radial assembly was developed, wherein a radial hole is defined in the nut for passage and installation of the circulating element during assembly. Although it can overcome the interference between the nail portion of the conventional circulating element and the helical groove of the screw shaft, this radial assembly still has other problems:

First, the radial hole of the nut breaks the tightness of the nut, sot that the vibration noise generated during the rolling motion of the balls will rush out without reserve.

Second, the radial hole assembled circulating element is so stable as the axially assembled circulating element and is more likely to loosen, and even worse, it will damage the ball screw structure.

The present invention has arisen to mitigate and/or obviate the afore-described disadvantages.

### SUMMARY OF THE INVENTION

The primary objective of the present invention is to provide a sectional circulating assembly for a ball screw, wherein the helical groove doesn't need to extend to the shoulder portion of the screw shaft.

To obtain this objective, the sectional circulating assembly for a ball screw in accordance with the present invention comprises an inner circulating block and an outer circulating block. In assembly, the inner circulating block is initially placed between the screw shaft and the nut before the balls and the screw shaft are positioned, thus preventing the balls from dropping out and the interference with the threads. After the balls and the screw shaft are positioned, the outer circulating block is placed into the nut and to be engaged with the inner circulating block, and the outer circulating block is fixed to the nut. This assembly method by assembling the circulating assembly separately can prevent the balls from dropping out and the interference with the threads.

The secondary objective of the present invention is to provide an easily assembled, stably positioned and low noise sectional circulating assembly for a ball screw.

Unlike the conventional circulating element that it must deal with the problem of the nail portion's interference during assembly, the circulating assembly of the present invention uses its sectional structure to solve the problem of space interference, effectively simplifying the assembly process and time. In addition, the sectional circulating assembly is engaged with the screw shaft, and is fixed to the nut by a locking member. This method can fix the circulating assembly more stably and can maintain the tightness of the nut, thus preventing the leakage of noise.

The present invention will be more clear from the following description when viewed together with the accompanying drawings, which show, for purpose of illustrations only, the preferred embodiment in accordance with the present invention.

### BRIEF DESCRIPTION OF THE DRAWINGS

FIG. 1 is an illustrative view of showing a part of a conventional ball screw;

FIG. 2 is a perspective view of a circulating assembly for a ball screw in accordance with the present invention;

FIG. 3 is an assembly view of the circulating assembly for a ball screw in accordance with the present invention;

FIG. 4 is an exploded view of the circulating assembly for a ball screw in accordance with the present invention;

FIG. 5 is an operational view of a circulating assembly for a ball screw in accordance with the present invention;

FIG. 6 is an illustrative view in accordance with the present invention of showing that the inner circulating block is being inserted in the axial direction;

FIG. 7 is an illustrative view in accordance with the present invention of showing that the inner circulating block is pushed into placed in the radial direction; and

FIG. 8 is an illustrative view in accordance with the present invention of showing the outer circulating block.

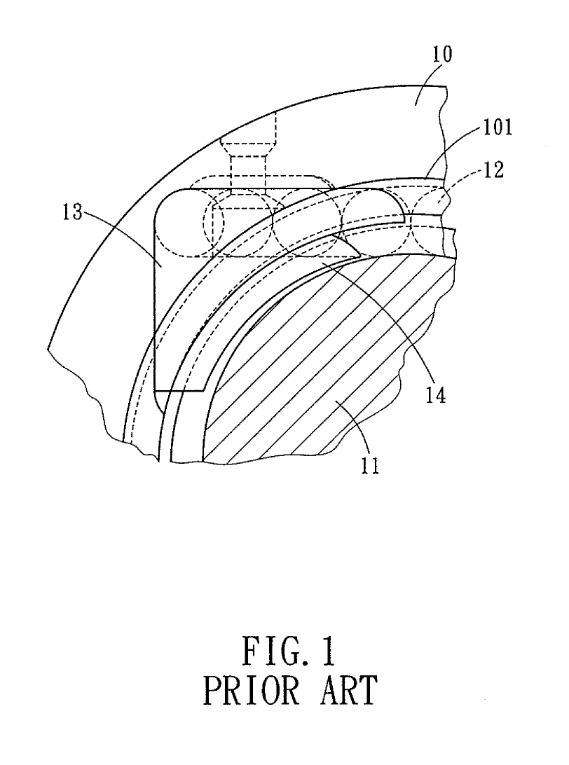

### DETAILED DESCRIPTION OF THE PREFERRED EMBODIMENT

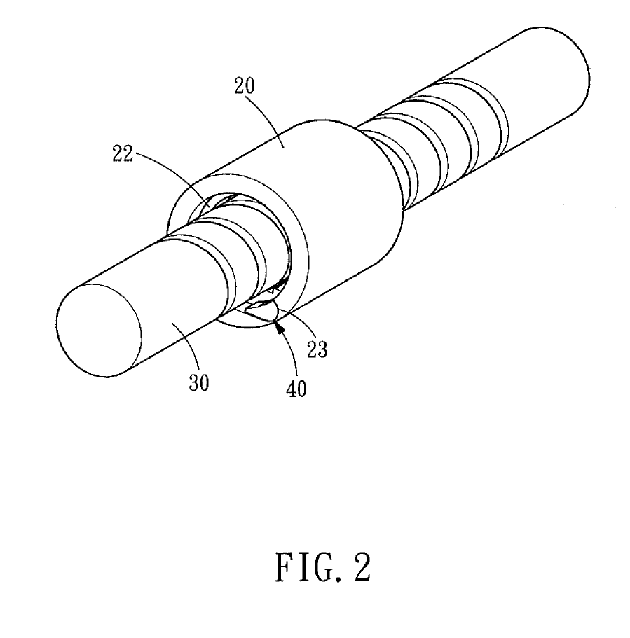

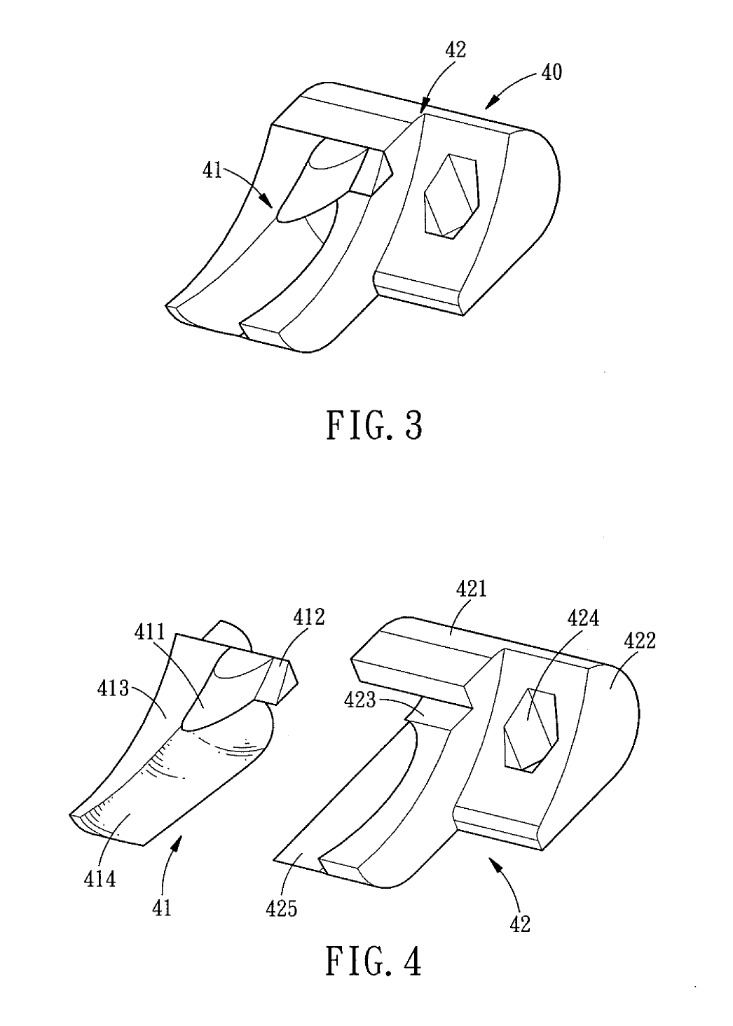

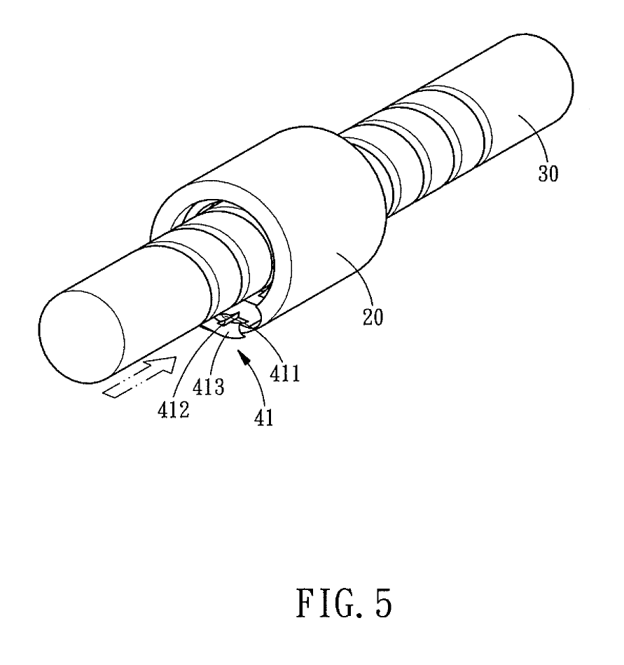

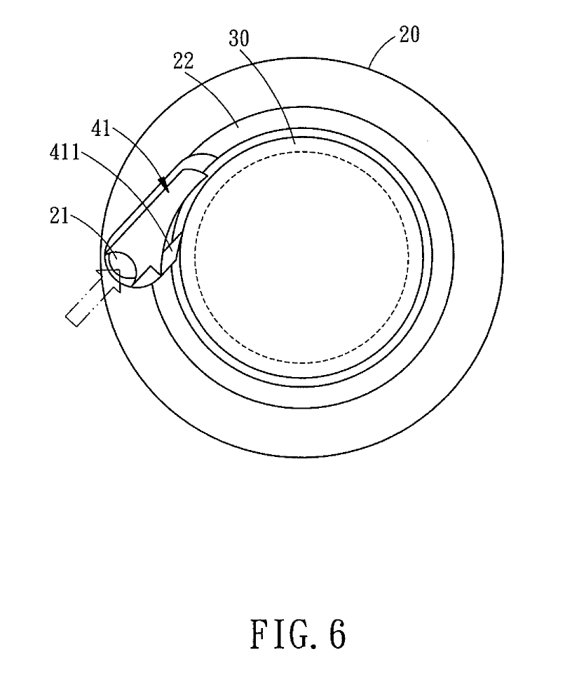

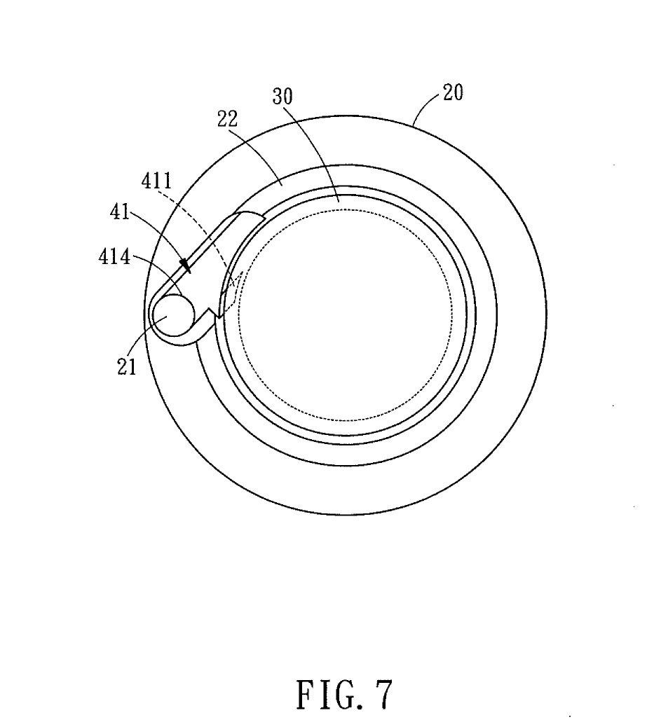

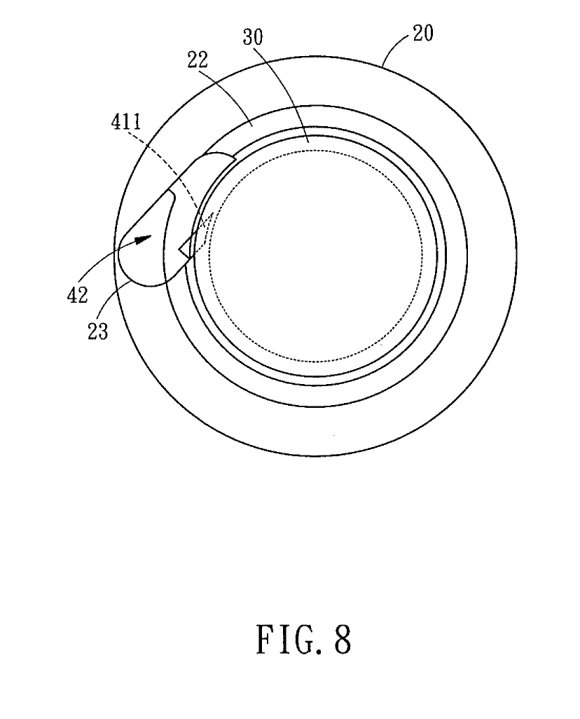

Referring to FIGS. 2-8, a circulating assembly in accordance with an embodiment of the present invention is illustrated and comprises: a nut 20, a screw shaft 30, a circulating assembly 40 and a plurality of balls.

The nut 20 is defined with a circulating hole 21 penetrating the body thereof, a helical groove 22 formed in the inner surface of the circulating hole 21, and a recess 23 formed in the end surface of the nut 20 and located correspondingly to the helical groove 22 and the circulating hole 21.

The screw shaft 30 is defined in its outer surface with a helical groove 31 and is inserted in the nut 20. The helical groove 31 cooperates with the helical groove 22 of the nut 20 to define a space for receiving the plurality of balls.

The circulating assembly 40 includes an inner circulating block 41 and an outer circulating block 42 and is received in the recess 23 of the nut 20.

The inner circulating block 41 is a unitary structure and includes a nail portion 411, a protruding portion 412, and a body 413 having an inner guideway 414. The nail portion 411 extends from the body 413 into the helical groove 31 of the screw shaft 30 and is positioned therein. The body 413 is engaged in the helical groove 22 of the nut 20. The inner guideway 414 of the body 413 serves to smoothly joint the helical groove 22 to the circulating hole 21 of the nut 20, and the protruding portion 412 protrudes therefrom.

The outer circulating block 42 includes a body 421 and a protruding ear 422. An outer guideway 425 is formed in the body 421 of the outer circulating block 42 for mating with the inner guideway 414 of the inner circulating block 41, so as to form a complete circulating passage. The body 421 is engaged in the helical groove 22 of the nut 20. A groove 423 is formed in the body 421 and is located toward the inner circulating block 41 and is to be engaged with the protruding portion 412 of the inner circulating block 41. A locking hole 424 is formed in the protruding ear 422 and serves to fix the protruding ear 422 to the nut 20 by cooperating with a locking member (not shown), so that the circulating assembly 40 can be positioned in the recess 23 of the nut 20 firmly.

The inner circulating block 41 and the outer circulating block 42 of the circulating assembly 40 can be provided with a plurality of protruding portions 412 and grooves 423, respectively, and the position of the protruding portions and grooves can be changed according to needs.

In assembly, the screw shaft 30 is initially inserted in the nut 20, a space is defined between the helical groove 31 of the screw shaft 30 and the helical groove 22 of the nut 20 for receiving a plurality of balls. After that, the inner circulating block 41 is placed into recess 23 and then slightly moves in the radial direction so as not to make the nail portion 411 interfere with the screw shaft 30. After the inner circulating block 41 is axially pushed into a predetermined position in the helical groove 22 of the nut 20, the user then pushes the inner circulating block 41 into place toward the radial direction thereof. At this moment, the inner guideway 414 in the body 413 of the inner circulating block 41 cooperates with the outer guideway 425 of the outer circulating block 42 to form a complete circulating passage, and thus the helical groove 22 is smoothly connected to the circulating hole 21 of the nut 20 by this circulating passage.

And then, a plurality of balls is put into place, after that, the outer circulating block 42 is placed into the recess 23 of the nut 20 and is engaged in the helical groove 423 of the outer circulating block 42, and the groove 423 of the outer circulating block 42 is engaged with the protruding portion 412 of the inner circulating block 41.

Finally, the locking member (not shown) is inserted through the locking hole 424 of the protruding ear 422 and locked in the nut 20, so that the circulating assembly 40 is positioned in the recess 23 of the nut 20 stably. This assembly method by assembling the circulating assembly 40 separately can prevent the balls from dropping out and the interference with the threads.

It is more important that since the inner and outer circulating blocks 41, 42 of the circulating assembly 40 are installed into the recess 23 of the nut 20 separately, the nail portion 411 will not interfere with the screw shaft 30, and the disassembled inner circulating block 41 can enter the space between the screw shaft 30 and the nut 20 very easily. Hence, it is unnecessary to define a notch in the shoulder portion of the screw shaft 30, the disadvantages of the prior art can be overcome, and the application range of the ball screw of the present invention is broadened.

On the other hand, since the inner and outer circulating blocks 41, 42 of the circulating assembly 40 are installed into the recess 23 of the nut 20 separately, this method doesn't require any radial holes to be formed to avoid the interference of the nail portion. The locking hole 424 allows the protruding ear 422 to be firmly assembled with the nut 20 and can maintain the tightness of the nut 20, preventing the leakage of noise.

To summarize, the sectional circulating assembly for a ball screw in accordance with the present invention comprises an inner circulating block and an outer circulating block. In assembly, the inner circulating block is initially placed between the screw shaft and the nut before the balls and the screw shaft are positioned, thus preventing the balls from dropping out and the interference with the threads. After the balls and the screw shaft are positioned, the outer circulating block is placed into the nut and to be engaged with the inner circulating block, and the outer circulating block is fixed to the nut. This method can maintain the tightness of the nut, thus preventing the leakage of noise.

While we have shown and described various embodiments in accordance with the present invention, it is clear to those skilled in the art that further embodiments may be made without departing from the scope of the present invention.

What is claimed is:

1. A sectional circulating assembly for a ball screw axially positioned in a recess in an end surface of a nut, the recess located correspondingly to a helical groove and a circulating hole of the nut, the sectional circulating assembly being characterized in that:
the sectional circulating assembly comprises an inner circulating block and an outer circulating block, the inner circulating block includes a nail portion and a body having an inner guideway, the nail portion extends from the body into the helical groove of a screw shaft and is positioned therein, an outer guideway is formed in the outer circulating block for mating with the inner guideway of the inner circulating block, the inner circulating block and the outer circulating block are axially assembled and positioned, so as to form a complete circulating passage, and the circulating passage servers to join the helical groove to the circulating hole of the nut, the inner circulating block is disposed in the bottom of a receiving groove of the nut, and the outer circulating block covers outside the inner circulating block.

2. The sectional circulating assembly for a ball screw as claimed in claim 1 serves to cooperate with a nut, the screw shaft and a plurality of balls, wherein
the nut is defined with a circulating hole, a helical groove formed in an inner surface of the circulating hole, and the recess formed in the end surface of the nut and located correspondingly to the helical groove and the circulating hole;
the screw shaft is defined in its outer surface with a helical groove and is inserted in the nut, a space is defined between the helical groove and the helical groove of the nut for receiving the plurality of balls; and
the inner circulating block is a unitary structure and includes the nail portion, a protruding portion, and the body having the inner guideway, the protruding portion protrudes outward, a body of the outer circulating block is engaged in the helical groove of the nut, a groove is formed in the body of the outer circulating body and is located toward the inner circulating block and is to be engaged with the protruding portion of the inner circulating block.

3. The sectional circulating assembly for a ball screw as claimed in claim 1, wherein a protruding ear is formed on the outer circulating block, a locking hole is formed in the protruding ear and serves to fix the protruding ear to the nut by cooperating with a locking member.
